(19) United States
(12) Patent Application Publication
(10) Pub. No.: US 2002/0082949 A1
(43) Pub. Date: Jun. 27, 2002

(54) Method and system for product planning

(76) Inventors: Joseph L. Desormeaux JR., Simsbury, CT (US); Philip P. Beauchamp, Rexford, NY (US); James Petrizzi, Tariffville, CT (US)

Correspondence Address: John S. Beulick, Armstrong Teasdale LLP, Suite 2600, One Metropolitan Sq., St. Louis, MO, 63102, US

(21) Appl. No.: 09/749,315

(22) Filed: Dec. 27, 2000

(51) Int. Cl. G06F 17/60

(52) U.S. Cl. 705/27; 705/8

(57) ABSTRACT

A web-based method and system for product planning for business includes receiving information concerning the attributes of a product from a user and using a server to compile the information and the relative importance of those attributes as judged by a user, and to disseminate the results of that compilation.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to computer network-based wizards and more particularly to a network-based method and system for receiving, compiling, and disseminating information concerning attributes of a product.

Corporations typically plan products carefully to meet customers' requirements. Soliciting, receiving, and incorporating the attributes desired by a geographically dispersed group of customers into the design of a product planned by an equally dispersed group of employees of a corporation presents a challenging problem. The problem becomes more pronounced when product attributes that may conflict with each other are balanced against cost and time to market considerations. At present, product planning often requires a series of meetings and extensive travel, with substantial attendant costs in both time and money. It would therefore be desirable to have a method for soliciting, receiving, compiling, and disseminating information concerning attributes of a product that could be used over a large geographical area by both consumers and producers of the product.

### BRIEF SUMMARY OF THE INVENTION

In an exemplary embodiment, a network-based method and system for receiving, compiling, and disseminating information concerning attributes of a product includes receiving information from a user relating to attributes of a product, and allowing a user to view the information and to register the relative importance a user places on one or more of the attributes.

The information relating to a product's attributes may include, for example, features of the product, cost of the product, time to market for the product, functionality of the product, reliability of the product, performance of the product, and ease of installation of the product. The web-based method and system provides a collaborative environment for users who are physically remote from each other.

### BRIEF DESCRIPTION OF THE DRAWINGS

FIG. 1 is a block diagram of a system in accordance with one embodiment of the present invention;

FIG. 2 is an expanded block diagram of a web-based method for soliciting, receiving, compiling, and disseminating information concerning attributes of a product;

FIG. 3 is a block diagram illustrating network connectivity;

FIG. 4 is a flow diagram of a web-based method for soliciting, receiving, compiling, and disseminating information concerning attributes of a product;

FIG. 5 is a screen shot of an exemplary embodiment of a connected status screen page;

FIG. 6 is a screen shot of an exemplary embodiment of a customer down-select process page;

FIG. 7 shows an exemplary embodiment of a facilitator down-select page;

FIG. 8 shows an exemplary embodiment of a customer only ranking process page;

FIG. 9 shows an exemplary embodiment of a facilitator ranking summary page;

FIG. 10 shows an exemplary embodiment of a total customer ranking summary page;

FIG. 11 shows an exemplary embodiment of a facilitator ranking page;

FIG. 12 shows an exemplary embodiment of a customer ranking page including a CI ranking;

FIG. 13 shows an exemplary embodiment of a customer interactive determination screen;

FIG. 14 shows an exemplary embodiment of a facilitator interactive determination screen; and

FIG. 15 is a flow chart of a web-based system for soliciting, receiving, compiling, and disseminating information concerning attributes of a proposed product in use.

### DETAILED DESCRIPTION OF THE INVENTION

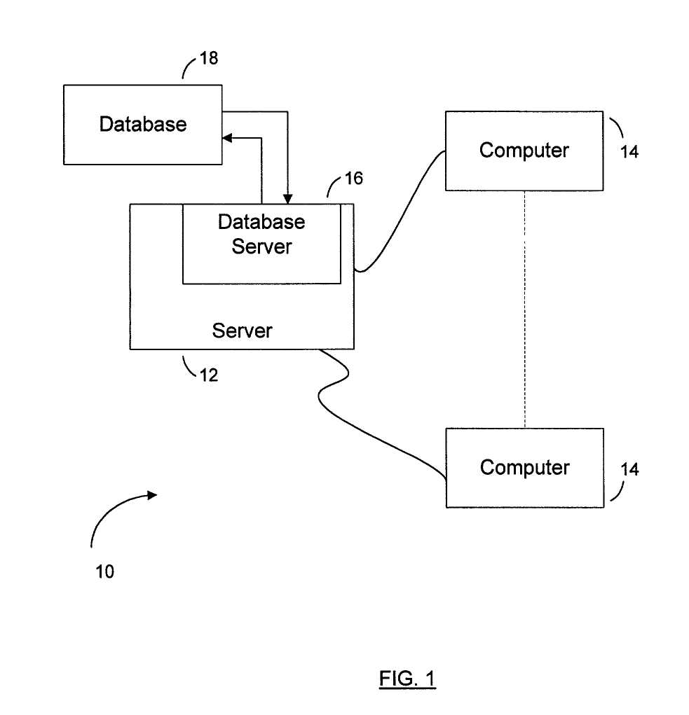

FIG. 1 is a block diagram of a system 10 for soliciting, receiving, compiling, and disseminating information concerning attributes of a product in accordance with one embodiment of the present invention. System 10 includes a server sub-system 12 (sometimes referred to herein as server 12) and a plurality of user devices 14 connected to server sub-system 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a web-based phone or other web-based connectable equipment. Server sub-system 12 includes a database server 16 connected to a centralized database 18 containing product-related information, as described below in greater detail. In one embodiment, centralized database 18 is stored on database server 16 and can be accessed by potential users at one of user devices 14 by logging onto server sub-system 12 through one of user devices 14. In an alternative embodiment centralized database 18 is stored remotely from server sub-system 12.

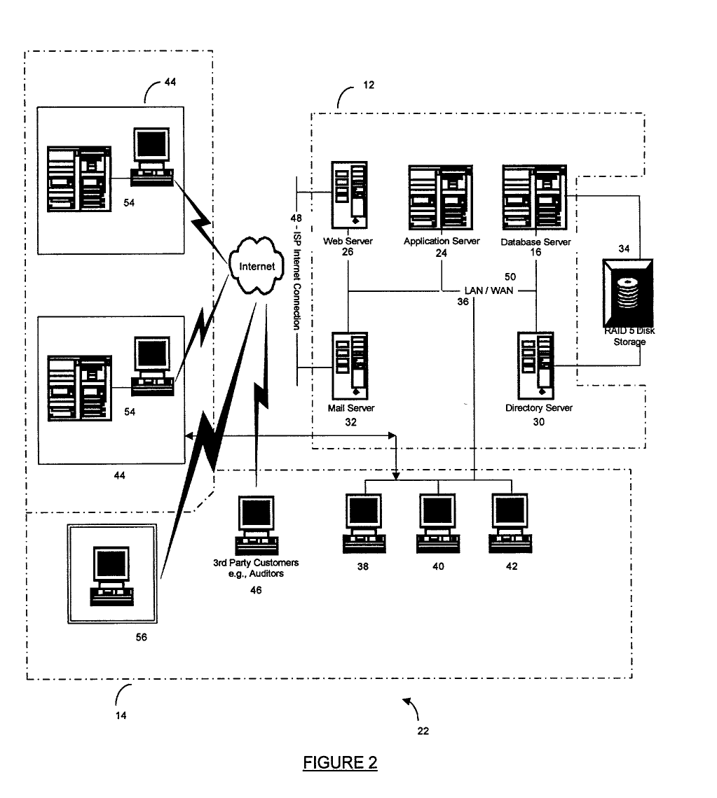

FIG. 2 is an expanded version block diagram of an exemplary embodiment of a server architecture of a system 22 for soliciting, receiving, compiling, and disseminating information concerning attributes of a product. System 22 includes server sub-system 12 and user devices 14. Server sub-system 12 includes database server 16, an application server 24, a web server 26, a directory server 30, and a mail server 32. A disk storage unit 34 is coupled to database server 16 and directory server 30. Servers 16, 24, 26, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to users 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any authorized individual or an employee of the business entity having a workstation 52 can access server sub-system 12. One of user devices 14 includes a senior manager's workstation 54 located at a remote location. Work stations 52 and 54 are personal computers having a web browser. Also, work stations 52 and 54 are configured to communicate with server sub-system 12. Furthermore, at least one of servers 16, 24, 26, 30 and 32 communicate with employees located outside the business entity and any of the remotely located user systems, including a user system 56 via a telephone link. Servers 16, 24, 26, 30, and 32 are configured to communicate with other workstations 38, 40, and 42 as well.

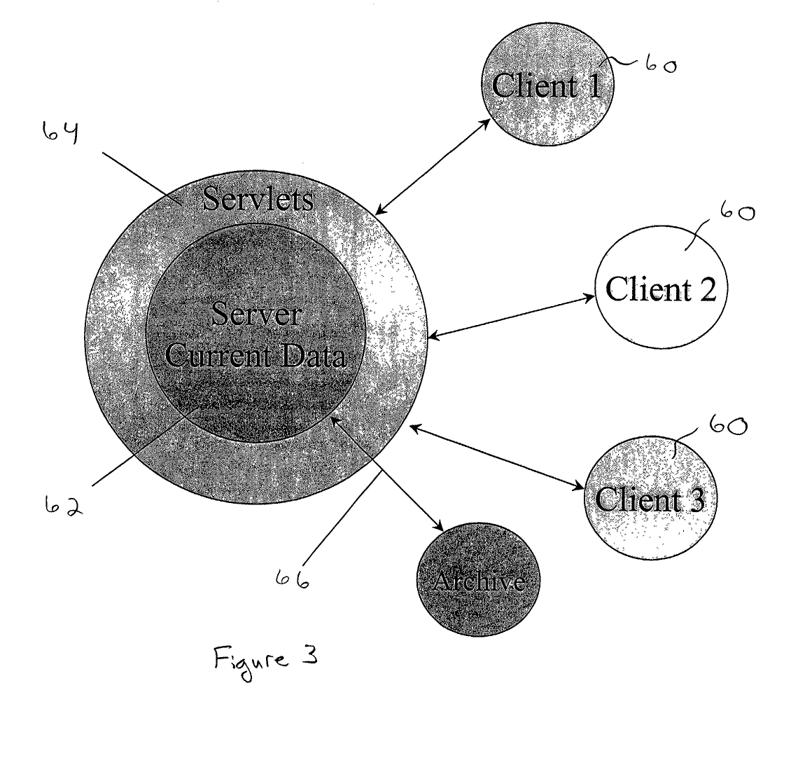

FIG. 3 is a block diagram illustrating network connectivity. As shown in FIG. 3, client applets 60 communicate with server 62 via servlets 64. An archive applet 66 communicates directly with server 62. Client applets 60 send action messages to servlets to perform operations on data or send messages to retrieve data. Servlets 64 synchronize views of different users based on roles and data, retrieve data for users when requested, and perform actions on data when requested by users. In addition, servlets send messages to clients of changes in data. Permission is needed by servlets 64 from client applets 06 for retrieving sent data. Server 62 includes current data which is accessible in a dynamic environment.

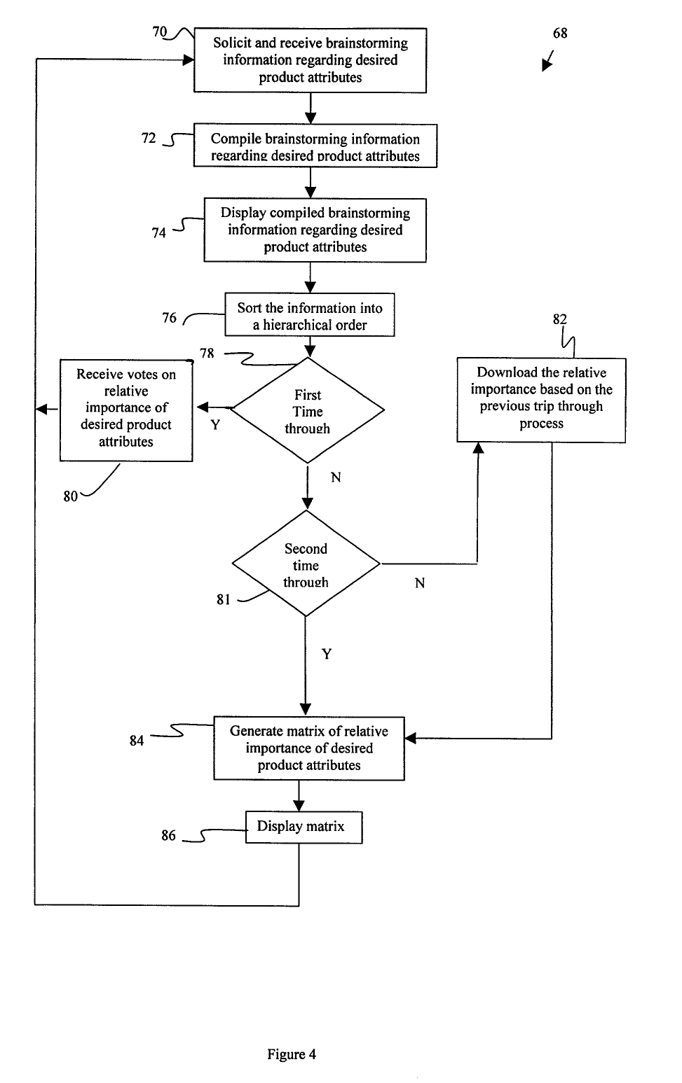

FIG. 4 is a flow chart showing a method 68 for soliciting, receiving, compiling, and disseminating information concerning attributes of a proposed product. System 10 (shown in FIG. 1) solicits and receives 70 brainstorming information regarding desired product attributes from users who are customers. In one embodiment, the information is solicited by a facilitator. System 10 compiles 72 the brainstorming information received regarding desired product attributes and displays 74 the compiled brainstorming information regarding desired product attributes on user device 14 (shown in FIG. 1). System 10 sorts 76 the compiled information into a hierarchical order. In one embodiment, the facilitator directs the system on how to rank the system.

System 10 then determines 78 whether this is a first time through process 68. If this is a first time through process 68, system 10 receives 80 votes on a relative importance of desired product attributes identified in the brainstorming session. Process 68 is repeated by system 10 soliciting and receiving 70 brainstorming information, compiling 72 brainstorming information regarding desired product attributes, displaying 74 compiled brainstorming information regarding desired product attributes and sorting 76 the information into a hierarchical order. If system 10 determines 78 this is not a first time through process 68, system 10 determines 81 whether this is a second time through process 68. If this is not a second time through process 68, i.e., if there have been more than two passes through process 68, system 10 downloads 82 the relative importance based on previous rounds of process.

If system 10 determines 81 this is the second time through process 68, or after system 10 downloads 82 the relative importance based on previous rounds of process, system 10 then tabulates the results of the votes and generates 84 a matrix of the relative importance of the desired product attributes vs. the identity of the customer and displays 86 the matrix on user device 14. Process 68 is repeated until the brainstorming session is completed and a consensus has been reached with respect to the customer importance of all of the attributes.

FIG. 5 shows an exemplary embodiment of a connected status screen page, as depicted in screen shot 88, which informs users of the identity of users who are online, their role in the product planning session, their company affiliation, and location. Screen shot 88 includes an online field 90 indicating whether a given person is online at that time, a name field 92 displaying the name of the user, a role field 94 that describes the role of the user in the product planning process, a business field 96 describing the user's employer, and a location field 98 describing where the user is located.

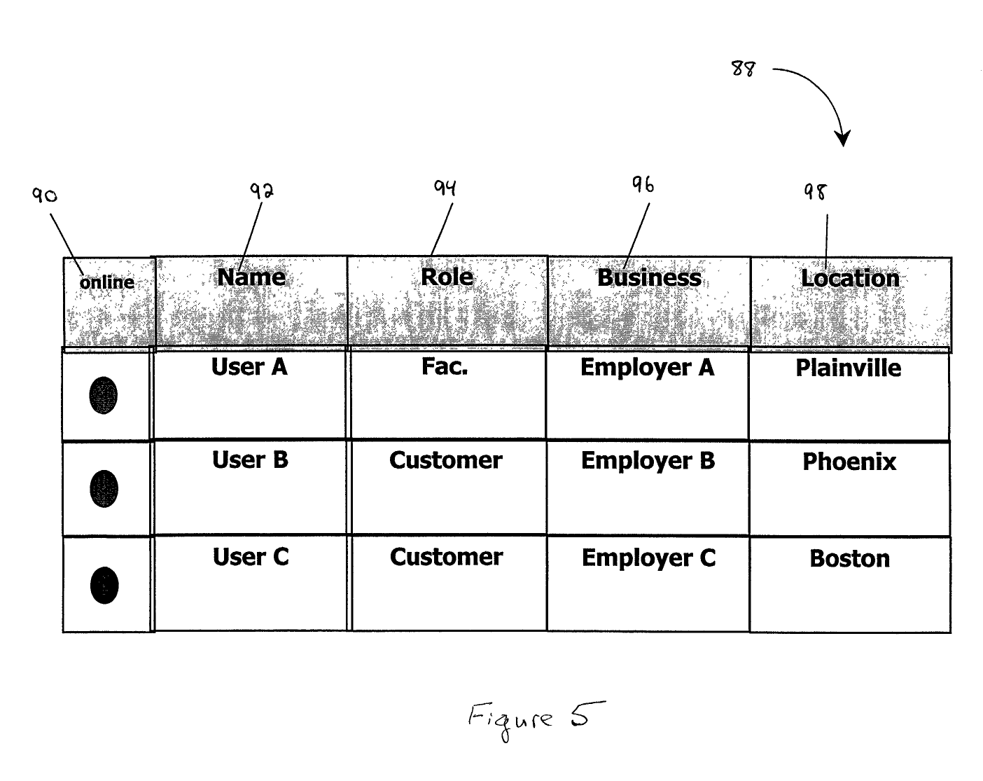

FIG. 6 shows an exemplary embodiment of a customer down-select process page displayed by system 10 (shown in FIG. 1) as depicted in screen shot 100. Screen shot 100 includes a down-select field 102, and a brainstormed input field 104. A display area 106 shows exemplary attributes of a product and illustrates how a user down selects the significance of a given attribute. Screen shot 100 is available to all customers and is transmitted to a facilitator upon down-selection by each customer. Attributes are down-selected until multiple levels exist and all attributes at a specific level are at a similar level of detail. The attributes that are not down-selected are considered to be at the highest level of detail and are given the designation of “Y”. Those attributes that are down-selected are given the designation “X”.If multiple layers of X exist, the highest level is designated X₁, the next highest level is designated X₂, and the z highest level is designated X₂.

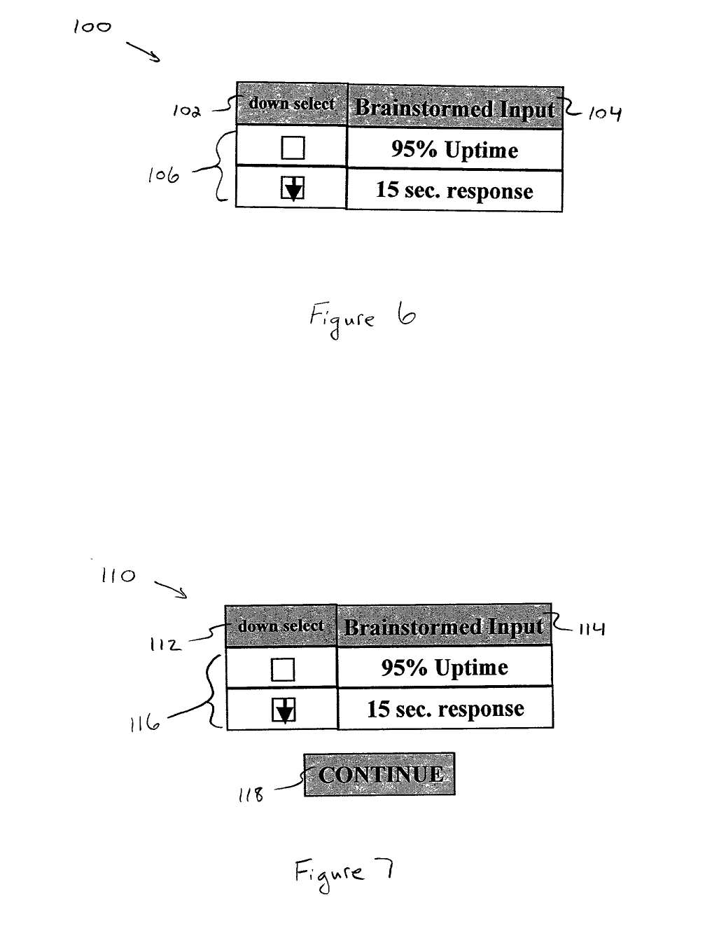

FIG. 7 shows an exemplary embodiment of a facilitator down-select page, as depicted in screen shot 110. Screen shot 110 includes a down select field 112, and a brainstormed input field 114. Screen shot 110 also includes an exemplary attribute display area 116 showing how attributes previously selected by customers are displayed. Screen shot 110 further includes a continue button 118, selection of which causes system 10 (shown in FIG. 1) to advance to the next attribute. Screen shot 110 is available only to the facilitator.

FIG. 8 shows an exemplary embodiment of a customer only ranking process page, as depicted in screen shot 120. Screen shot 120 includes a customer display area 122 that lists customer Y's 124 and a rank 126 assigned to each Y by a customer through use of an interactive dot ranking method. When the customer is finished assigning ranks to the listed Y's, the customer selects a send button 128 that results in the selections being sent to server 12 (shown in FIG. 1).

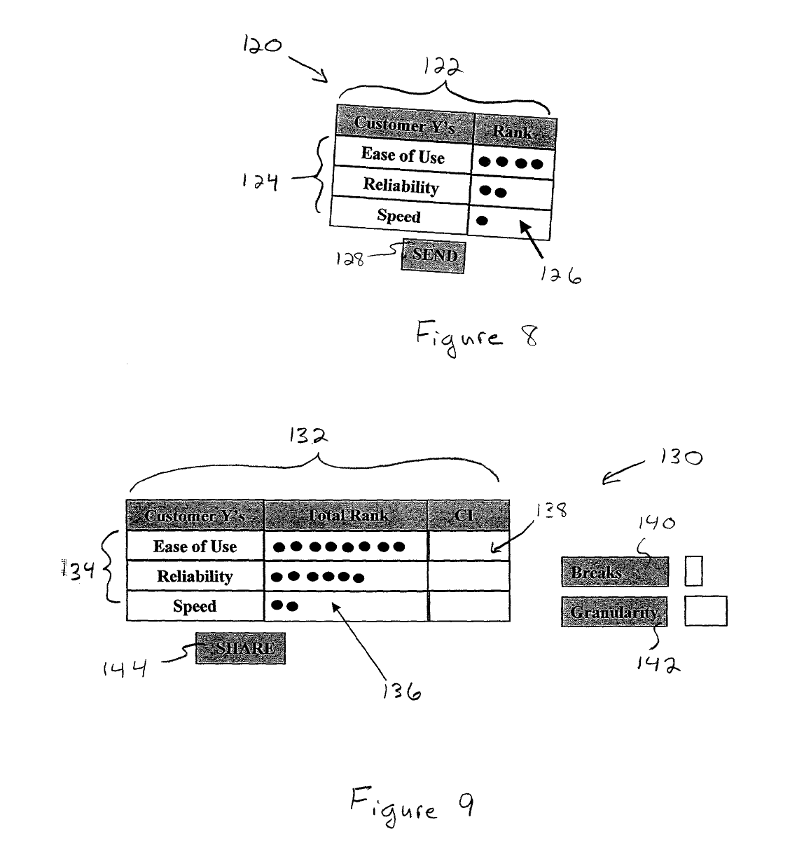

FIG. 9 shows an exemplary embodiment of a facilitator ranking process page, as depicted in screen shot 130. Screen shot 130 includes a facilitator screen display area 132 that shows customer Y's 134, a total rank field 136, and a CI (customer importance) field 138. Total rank field 136 includes an overall rank returned by all customers who responded to the poll for each Y. Screen shot 130 also includes a breaks button 140 and a granularity button 142. Breaks button 140 and granularity button 142 are utilized to provide a ranking breakdown of the Y's voted on by the customers as will be described below in greater detail. Screen shot 130 further includes a share button 144, selection of which by the facilitator transmits screen shot 130 to server 12 (shown in FIG. 1) which transmits screen shot 130 to all of the customers who responded to the poll.

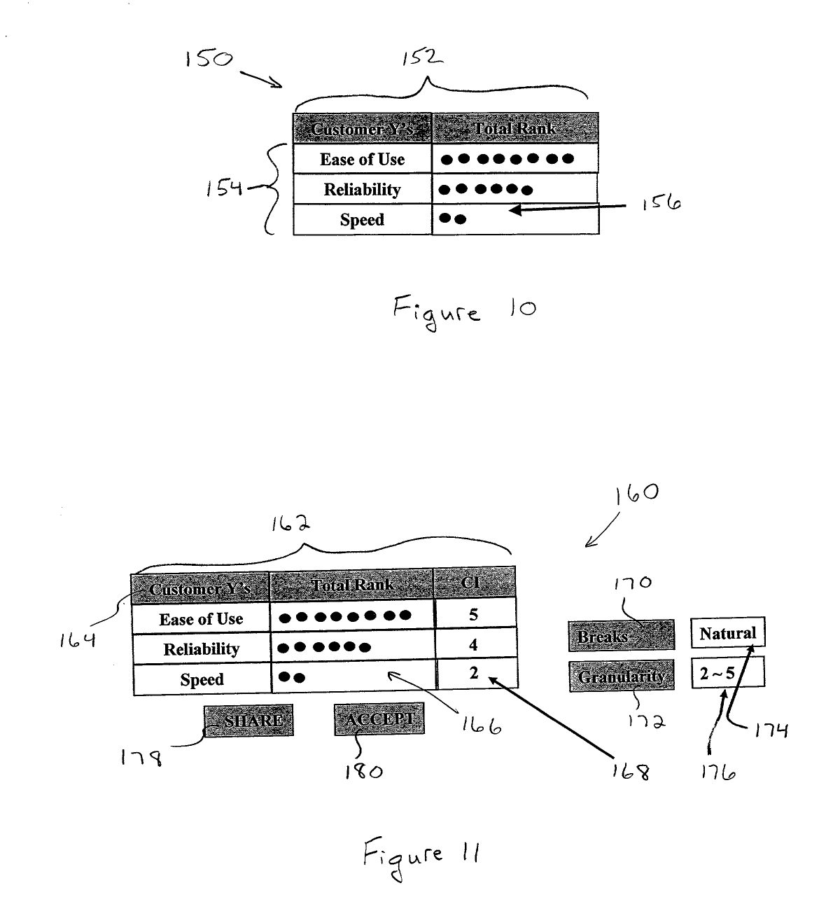

FIG. 10 shows an exemplary embodiment of a customer screen as depicted in screen shot 150. The customer screen in screen shot 150 is shared with the customers by the facilitator upon selection of share button 144 (shown in FIG. 8). Screen shot 150 includes a facilitator screen display area 152 that shows a customer Y's field 154 and a total rank field 156. Customer Y's field 154 includes all attributes voted on by the customers and total rank field 156 includes the total rank given to each Y by all of the voting customers.

FIG. 11 shows an exemplary embodiment of a facilitator ranking page, as depicted in screen shot 160. Screen shot 160 includes a facilitator screen display area 162 that shows customer Y's 164, a total rank field 166, and a CI field 168. Screen shot 160 also includes a breaks button 170 and a granularity button 172. Selection of breaks button 170 provides a listing of breaks selection options 174. Breaks selection options include, in one embodiment, a uniform breaks and a natural breaks options. Uniform breaks allows the facilitator to manually determine the breaks based on a judgment of the data. Natural breaks provides a ranking of the attributes based on how large the gaps are between the different attributes. Selection of granularity button 172 provides a listing of numerical range options 176. In one embodiment the listings are provided in drop down menus. CI field 166 includes a numerical ranking normalized, for example, to a 5-0 scale and based on breaks selection options 174 and numerical range options 176. Screen shot 160 further includes a share button 178 and an accept button 180. Selection of share button 178 by the facilitator transmits screen shot 160 to server 12 (shown in FIG. 1) which transmits screen shot 160 to all of the customers who responded to the poll. Selection of accept button 180 finalizes the voting and stores the results in database 18 (shown in FIG. 1).

FIG. 12 shows an exemplary embodiment of a customer screen as depicted in screen shot 190. The customer screen in screen shot 190 is shared with the customers by the facilitator upon selection of share button 178 (shown in FIG. 10). Screen shot 190 shares the CI information obtained by the facilitator with the customers. Screen shot 190 includes the same information contained on screen shot 160 (shown in FIG. 10) except that share button 178 and accept button 180 (shown in FIG. 10) are not included on screen shot 190.

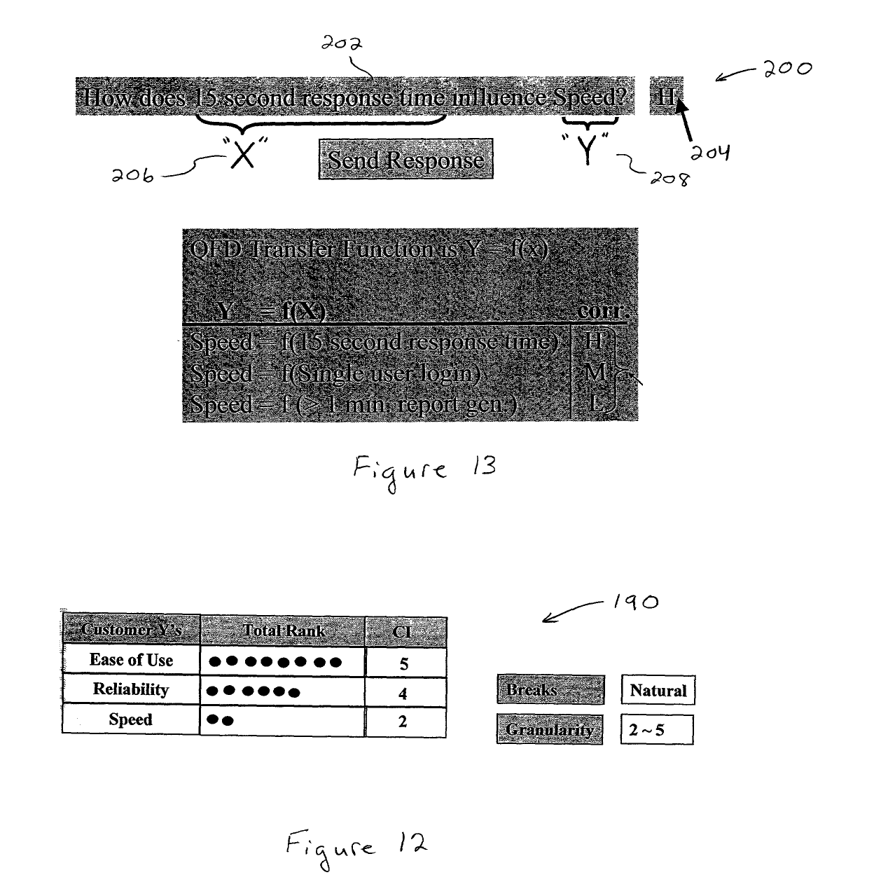

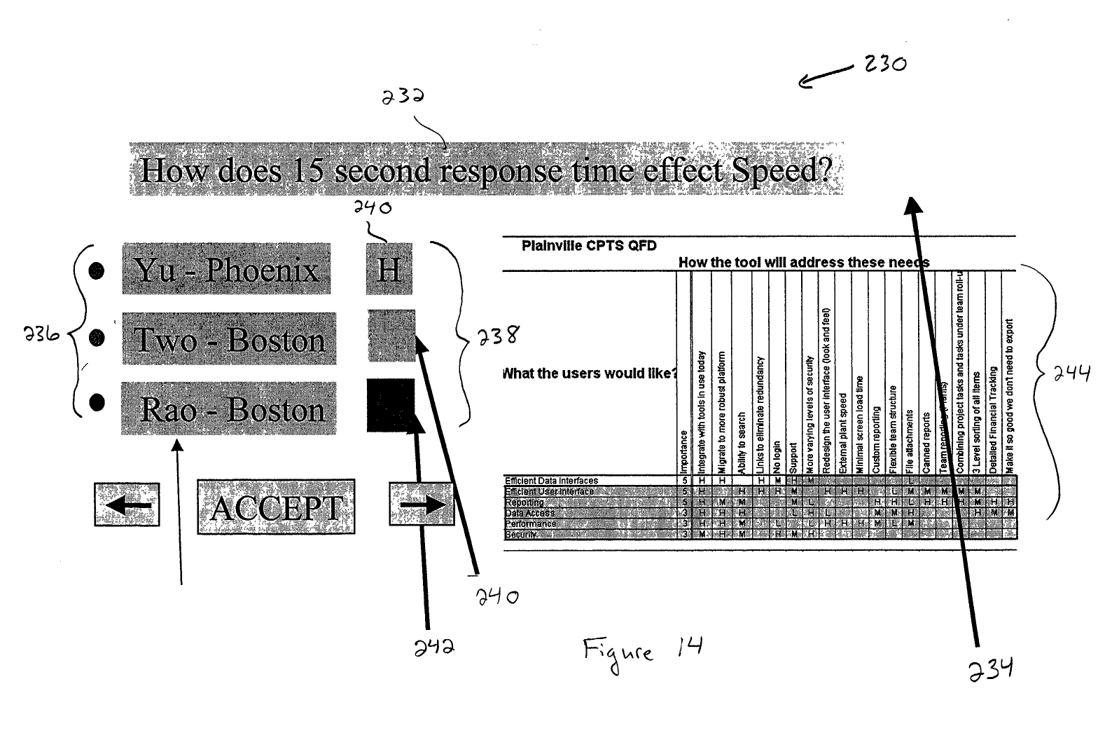

FIG. 13 shows an exemplary embodiment of a customer interactive determination screen depicted in screen shot 200. Screen shot 200 includes a question 202 and an answer block 204 for that question. An answer is selected from answer block 204 which contains a listing, for example, in a pull down menu (not shown). Question 202 includes an X portion 206 and a Y portion 208. Screen shot 200 also includes a send response button 210, selection of which transmits the user's responses to server 12 (shown in FIG. 1) which then transmits the responses to a facilitator. Screen shot 200 is utilized to obtain information on relationships between X portion 206 and Y portion 208 of question 202. In addition, screen shot 200 includes a transfer function block 212 that includes a general transfer function 214 and a series of specific transfer functions 216 along with an associated correlation section 218. Correlation section 218, in one embodiment, includes a scroll capability and has, for example, selections such as H, M, L, and blank, corresponding to high, medium, low and no correlation.

FIG. 14 shows an exemplary embodiment of a facilitator interactive determination screen depicted in screen shot 230. Screen shot 230 includes a question 232 and an answer block 234 for that question. An answer for answer block 234 is determined by system 10 (shown in FIG. 1) from inputs receives from customers. In addition, screen shot 230 includes a listing of the users 236 logged onto system 10 and the response 238 each participant has provided for the presented question. The responses are coded such that a light block 240 with or without a letter indicates that voting has occurred. A dark box 242, with no letter indicates that that particular person has not yet voted on the presented question. User listing 236 is an expandable listing which allows the facilitator to view any of the information available with respect to that user which was input at the user screen. Screen shot 230 also includes a master listing 244 of the combined results with respect to a series of questions and responses already presented to the customers.

In use, system 10 (shown in FIG. 1) comprises seven major categories, each of which corresponds to a different phase of the product planning process. These categories are roles/permissions, login, brainstorming, interactive data selecting, interactive voting, interactive determination of attribute relationships, and electronic publication of results.

Roles/Permissions specifies the access a user has to system 10 based upon the user's role in the product planning process. In one embodiment, roles include a facilitator/scribe, customer, sponsor, and observer. In this embodiment, the facilitator/scribe controls the meeting, process, and tool, and the decision of whether or not to proceed to next steps in the product planning process. A customer is able to participate interactively during voting, demoting or “down-selecting”, and determination of relationships between product features and customer-requested attributes. A sponsor is able only to participate interactively during demotion or “down-selection” and determination of relationships between product features and customer requested attributes. Observers are able to only observe the voting process, and are not able to provide input to the process.

Login is required for each user, and allows each user to be identified and a user's role in the process to be established. In one embodiment, each user is supplied with a user name and password to enter each product planning session. In a further embodiment, a status screen is provided so that each user can view the list of attendees of the product planning session. In another embodiment, system 10 includes an option that allows users to generate text that automatically generates records and sends a notice, optionally by email, to the person responsible for the action item.

Brainstorming occurs at several points in a product planning process. In one exemplary embodiment, brainstorming occurs via the telephone while a user (e.g., the facilitator) transcribes the brainstorming dialog into system 10 (shown in FIG. 1), which displays the transcribed text to at least one user device 14, thereby allowing all users to access the same information virtually and instantaneously. In one embodiment, system 10 offers each user, one at a time, the opportunity to contribute an entry or to pass if the user has no new entry. The facilitator records contributed ideas, and after a plurality of circuits of the login users, opens the contributed entries for discussion.

Interactive demotion or “down-selecting” allows each user to view a list of brainstorming items and to demote or “down-select” those items that are too detailed to belong in the current list. This interactive process allows each user to have access to an interactive real-time collaborative environment to discuss the user's selections during selections on remote terminals. Upon a user entering a selection, the selections from each user are shared with all other users currently on the system.

Interactive voting allows users who are also customers to cast votes to determine the relative importance of the customer-requested attributes. System 10 polls each user with a window of the customer-requested attributes generated during the brainstorming session, along with a voting box where the customers indicate their preferences. In one exemplary embodiment, system 10 allows customers to cast votes via the interactive dot ranking method.

Interactive determination of relationships between features and customer-requested attributes involves interactive responses from users who are customers and users who are employees of the manufacturer. In one embodiment, customers and employees electronically send their comments on each such relationship as it is presented to each user device 14 (shown in FIG. 1). In this embodiment, system 10 displays each relationship on each user's screen in transfer function format and provides the option to the user to characterize the relationship between the feature and the customer-requested attributes as nonexistent, low, medium, or high. Customer inputs are sent and shared in a real time collaboration environment. Once the group reaches consensus by discussion and/or additional voting, the facilitator accepts inputs and progresses the group to the next relationship aspect.

Electronic publication of the results of the product planning process is accomplished by having system 10 disseminate the results to each user device 14 (shown in FIG. 1). In addition, and in the exemplary embodiment, system 10 includes a file repository to store documents and templates to be used during product planning sessions. Examples of such documents and templates include an introduction, agenda templates, and straw man. In an alternative embodiment, system 10 uses a setup screen to assign multiple functions such as number of customers, sponsors, scribe, record of users' login and voting history.

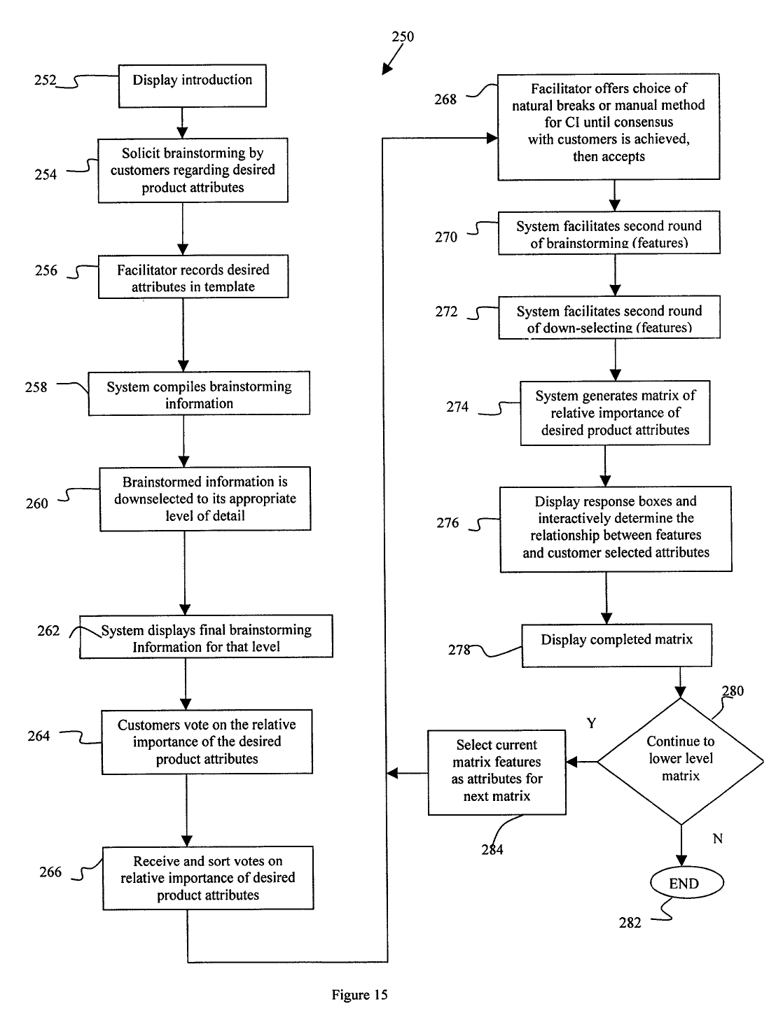

FIG. 15 shows a flow chart of the functionality of an exemplary embodiment of system 10 (shown in FIG. 1) as depicted in flow chart 250. System 10 displays 252 an introduction that describes the purpose of the product planning tool on each of user devices 14 (shown in FIG. 1). Those users who are customers then brainstorm 254 about the attributes they desire in the proposed product, while a facilitator records 256 their desired attributes in a template. System 10 compiles 258 the brainstorming information which is down-selected 260 to its appropriate level of detail.

The downselected brainstorming information, i.e,, the final brainstorming information for that level, is displayed 262 to the customers who vote 264 interactively on the relative importance of each of the desired attributes suggested during the brainstorming session. In one embodiment, the voting screen appears on each user device 14, and is optionally time-stamped with order of input. System 10 further includes a time out function such that if a user device is not receiving or transmitting information for a pre-set period of time, the user is logged-off so the other users understand that the particular user is not responding to the information sharing.

System 10 receives and sorts 266 the votes to identify those customer-requested attributes that they consider to be of importance. The facilitator offers 268 a choice of natural breaks or a manual method for CI until the facilitator achieves consensus with the customers, after which the facilitator accepts and finalizes the results. System 10 then facilitates 270 a second round of brainstorming and a second 272 down select process to identify features of customer selected attributes. After the second round of brainstorming and down-selecting is complete, system 10 generates 274 a matrix of customer-requested product attributes and features and their relative importance to each of the customers as reflected in the interactive voting.

System 10 then displays 276 the response boxes and interactively determines the relationship between features and the customer selected attributes of the product by requesting comments on how X affects Y along with a response box including a pull down menu with choices of high, medium, low, or none. System 10 then displays 278 the resulting completed and sorted matrix to each user device. It is then determined whether to continue 280 to a lower level matrix. If a lower level matrix is not desired, then process 250 ends 282. If a lower level matrix is desired, system 10 selects 284 the current matrix features as attributes for the next matrix.

System 10 then prompts the facilitator to again offer 268 a choice of natural breaks or a manual method for CI until the facilitator achieves consensus with the customers. The facilitator then accepts and finalizes the results. System 10 then facilitates progression through the remaining portion of the system functionality including facilitating 270 a second round of brainstorming and a second 272 down-select process, generating 274 a matrix and interactively determining 276 the relationship between features and customer selected attributes of the product. Then, system 10 displays 278 the resulting completed and sorted matrix to each user device. It is once again determined whether a lower level matrix is desired, and if a lower level matrix is desired, steps 268 through 278 are repeated.

System 10 facilitates a fast and easy method for exchanging data, specifically, for soliciting, receiving, compiling, and disseminating information concerning attributes of a product. System 10 is a network-based system and is configured to permit users to access system 10 from remote locations through devices 14. System 10 converts qualitative characteristics for the design efforts into quantitative measures and baselines that can be readily analyzed.

While the invention has been described in terms of various specific embodiments, those skilled in the art will recognize that the invention can be practiced with modification within the spirit and scope of the claims. For example, although the exemplary embodiment is described in the context of a product, in an alternative embodiment, the invention is utilized with a process.

What is claimed is:

1. A method for gathering information concerning attributes of a product through use of a network-based system including a server and at least one device connected to the server via a network, said method comprising the steps of:
receiving information concerning the product from a user via the device;
compiling the received information;
down-selecting the received information; and
displaying the down-selected information relating to the product to the users.

2. A method in accordance with claim 1 wherein said step of displaying information is performed on a device physically remote from the server.

3. A method in accordance with claim 2 wherein said step of receiving information is performed on a first device in a first room, and wherein said step of displaying information is performed on a second device in a second room.

4. A method in accordance with claim 1 wherein said step of receiving information comprises the step of receiving information pertaining to features selected by the user.

5. A method in accordance with claim 2 wherein the information comprises at least one of a desired attribute, ease-of-use, performance characteristics, and time to market.

6. A method in accordance with claim 1 wherein the information comprises a customer-requested feature of the product.

7. A method in accordance with claim 1 wherein the information comprises a specification for the product.

8. A method in accordance with claim 1 wherein the information comprises information regarding a user.

9. A method in accordance with claim 1 wherein the information includes votes from users on the relative importance of the information.

10. A method in accordance with claim 9 further comprising the steps of:
tabulating the votes; and
displaying the tabulated votes to the user.

11. A method in accordance with claim 9 further comprising the step of utilizing the information and the relative importance of the information to generate a matrix.

12. A method in accordance with claim 1 further comprising the step of receiving the product specification information from the user via a graphical user interface.

13. A method in accordance with claim 1 further comprising the step of determining relationships between features and customer-requested attributes.

14. A method in accordance with claim 13 further comprising the step of sharing the determined relationships real-time with other users.

15. A method for planning a product on a network connecting a plurality of users, the network comprising a server and a plurality of user display devices, said method comprising the steps of:
soliciting from the users information concerning a desirable attribute of a product;
compiling on the server the information received from the users;
displaying on the display devices the information received from the users;
down-selecting the received information;
polling the users to determine the relative importance each user places on the attribute, and
displaying on the display devices the information concerning the desirable attribute and the relative importance the group of user places on the attribute.

16. A method in accordance with claim 15 wherein at least one user is physically remote from another user.

17. A method in accordance with claim 15 wherein the information comprises information regarding a user.

18. A method in accordance with claim 15 wherein the information includes votes from users on the relative importance of the information.

19. A method in accordance with claim 15 wherein the votes are tabulated and displayed to the user.

20. A method in accordance with claim 15 further comprising the step of generating a matrix based on the information received and the relative importance of the received information.

21. A method in accordance with claim 15 further comprising the steps of:
determining relationships between features and customer-requested attributes; and
sharing the determined relationships real-time with other users.

22. A system for gathering information concerning attributes of a product, said system comprising:
a device; and
a server connected to said device and configured to receive product specification information data from a user via said device, said server further configured to:
compile the received information;
display to the user information related to the product;
facilitate a down-selection process of the received information; and
display the results of the down-selection on said device.

23. A system in accordance with claim 22 wherein said server is further configured to receive information pertaining to features selected by the user.

24. A system in accordance with claim 22 wherein said server is further configured to receive information regarding at least one of a desired attribute, ease-of-use, performance characteristics, and time to market.

25. A method in accordance with claim 22 wherein the information comprises information regarding a user.

26. A method in accordance with claim 22 wherein the information includes votes from users on the relative importance of the information.

27. A method in accordance with claim 22 wherein the votes are tabulated and displayed to the user.

28. A method in accordance with claim 22 wherein the information and the relative importance of the information are used to generate a matrix.

29. A system in accordance with claim 22 wherein said server further configured to receive the product information from the user via a graphical user interface.

30. A system in accordance with claim 22 wherein said device configured to be a server for a network of customer devices.

31. A system in accordance with claim 22 wherein said server and said device are connected via a network.

32. A system in accordance with claim 31 wherein said network is one of a wide area network, a local area network and the Internet.
